(19) United States
(12) Patent Application Publication
(10) Pub. No.: US 2015/0213258 A1
(43) Pub. Date: Jul. 30, 2015

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Takanori MASUI, Yokohama-shi (JP)

(73) Assignee: FUJI XEROX CO., LTD., Tokyo (JP)

(21) Appl. No.: 14/450,649

(22) Filed: Aug. 4, 2014

(30) Foreign Application Priority Data
Jan. 24, 2014 (JP) 2014-011633

(51) Int. Cl. G06F 21/45; G06F 21/60

(52) U.S. Cl. CPC G06F 21/45; G06F 21/60

(57) ABSTRACT

An information processing apparatus includes a warning unit. The warning unit outputs a warning to change authentication information from an initial setting value in a case when the authentication information has not been changed from the initial setting value, the authentication information being used for authentication for using at least one service in which information held by the information processing apparatus is provided via a communication unit.

### CROSS-REFERENCE TO RELATED APPLICATIONS

This application is based on and claims priority under 35 USC 119 from Japanese Patent Application No. 2014-011633 filed Jan. 24, 2014.

### BACKGROUND

### Technical Field

The present invention relates to an information processing apparatus and a non-transitory computer readable medium.

### SUMMARY

According to an aspect of the invention, there is provided an information processing apparatus including a warning unit. The warning unit outputs a warning to change authentication information from an initial setting value in a case when the authentication information has not been changed from the initial setting value, the authentication information being used for authentication for using at least one service in which information held by the information processing apparatus is provided via a communication unit.

### BRIEF DESCRIPTION OF THE DRAWINGS

Exemplary embodiments of the present invention will be described in detail based on the following figures, wherein:

FIG. 1 is a diagram illustrating an example of the hardware configuration of an image processing apparatus according to an exemplary embodiment of the present invention;

FIGS. 2A and 2B are diagrams illustrating examples of a warning screen displayed in a first exemplary embodiment of the present invention;

FIG. 3 is a block diagram illustrating an example of the functional configuration of an information processing apparatus according to the first exemplary embodiment of the present invention;

FIG. 4 is a flowchart illustrating an operation example of the information processing apparatus according to the first exemplary embodiment of the present invention;

FIGS. 5A and 5B are diagrams illustrating examples of a warning screen displayed in a second exemplary embodiment of the present invention;

FIG. 6 is a block diagram illustrating an example of the functional configuration of an information processing apparatus according to the second exemplary embodiment of the present invention;

FIG. 7 is a flowchart illustrating a first operation example of the information processing apparatus according to the second exemplary embodiment of the present invention;

FIG. 8 is a flowchart illustrating a second operation example of the information processing apparatus according to the second exemplary embodiment of the present invention;

FIG. 9 is a block diagram illustrating an example of the functional configuration of an information processing apparatus according to a third exemplary embodiment of the present invention;

FIG. 10 is a flowchart illustrating a first operation example of the information processing apparatus according to the third exemplary embodiment of the present invention; and

FIG. 11 is a flowchart illustrating a second operation example of the information processing apparatus according to the third exemplary embodiment of the present invention.

### DETAILED DESCRIPTION

Hereinafter, exemplary embodiments of the present invention will be described in detail with reference to the attached drawings.

### Background

In recent years, image processing apparatuses having a function of accessing a network have been used. Such an image processing apparatus is normally designed under the assumption that the apparatus will be connected to a network protected by a firewall, and that the apparatus will be directly connected to the Internet.

However, in a network environment of universities, government agencies, or the like, an image processing apparatus may be directly connected to the Internet without protected by a firewall in some cases. Under such a connection state, it is often the case that a user uses the image processing apparatus with authentication data remaining the factory default, without recognizing that the apparatus is directly connected to the Internet. In this case, there is a risk that document data or the like stored in the image processing apparatus is accessed via the Internet, which may cause leakage of information.

On the other hand, in an environment in which an image processing apparatus is connected to a network protected by a firewall, the image processing apparatus is not accessed from the Internet. Thus, in a small organization having a low risk of leakage of information within the organization, it is desired that a user be allowed to use an image processing apparatus without performing an authentication operation or the like.

Accordingly, there is a demand for an image processing apparatus that is capable of reducing a risk of leakage of information in a network environment that is not protected by a firewall, while maintaining the compatibility with an environment in which a risk of leakage of information is low and convenience is emphasized.

### Hardware Configuration of Image Processing Apparatus

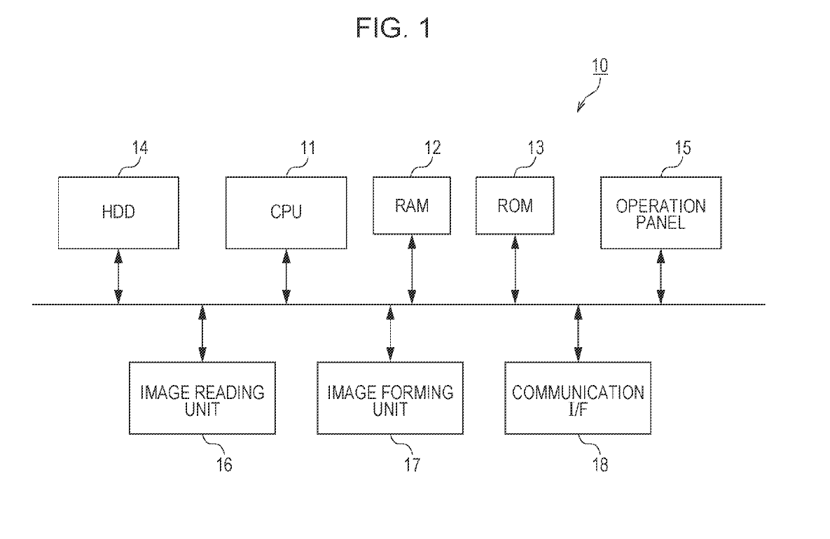

FIG. 1 is a diagram illustrating an example of the hardware configuration of an image processing apparatus 10 according to an exemplary embodiment. As illustrated in FIG. 1, the image processing apparatus 10 includes a central processing unit (CPU) 11, a random access memory (RAM) 12, a read only memory (ROM) 13, a hard disk drive (HDD) 14, an operation panel 15, an image reading unit 16, an image forming unit 17, and a communication interface (hereinafter referred to as a “communication I/F”) 18.

The CPU 11 loads various programs stored in the ROM 13 or the like to the RAM 12 and executes the programs, thereby implementing the functions described below.

The RAM 12 is a memory that is used as a working memory or the like of the CPU 11.

The ROM 13 is a memory that stores various programs or the like executed by the CPU 11.

The HDD 14 is, for example, a magnetic disk device that stores image data read by the image reading unit 16, image data that is to be used for image formation in the image forming unit 17, and so forth.

The operation panel 15 is a touch panel that displays various pieces of information and accepts input of an operation from a user. Here, the operation panel 15 includes a display, which is an example of a display screen on which various pieces of information are displayed, and a position detection sheet that detects a position indicated by an indicator such as a finger or a stylus pen.

The image reading unit 16 is an example of an image processing unit, and reads an image recorded on a recording medium, such as paper. Here, the image reading unit 16 is a scanner, for example. The scanner may be operated using a charge-coupled device (CCD) scheme in which light emitted from a light source onto a document and reflected thereby is condensed by a lens and is received by a CCD, or a contact image sensor (CIS) scheme in which light sequentially emitted from a light-emitting diode (LED) as a light source onto a document and reflected thereby is received by a CIS.

The image forming unit 17 is an example of an image processing unit, and forms an image on a recording medium. Here, the image forming unit 17 is a printer, for example. The printer may be operated using an electrophotographic system in which an image is formed by transferring toner adhered to a photoconductor onto a recording medium, or an inkjet system in which an image is formed by ejecting ink onto a recording medium.

The communication I/F 18 transmits and receives various pieces of information to/from another apparatus via a network.

### First Exemplary Embodiment

In a first exemplary embodiment, a warning is output in a case when authentication data for administrator has not been changed from a default.

The image processing apparatus 10 holds, for example, authentication data for administrator (user ID and password) used for authentication that is performed using a remote user interface (hereinafter referred to as a “remote UI”) provided by an embedded web server (EWS), authentication data for administrator (community string) used for authentication that is performed to make an access using a simple network management protocol (SNMP), and so forth. In a case when these pieces of authentication data for administrator for all the remotely accessible interfaces have not been changed from the default, there is a possibility that document data of the user or data of a log of print instructions will be accessed from the outside, and leakage of information occurs.

Accordingly, in the first exemplary embodiment, a warning is displayed so that the pieces of authentication data for administrator for all the interfaces are changed from the default.

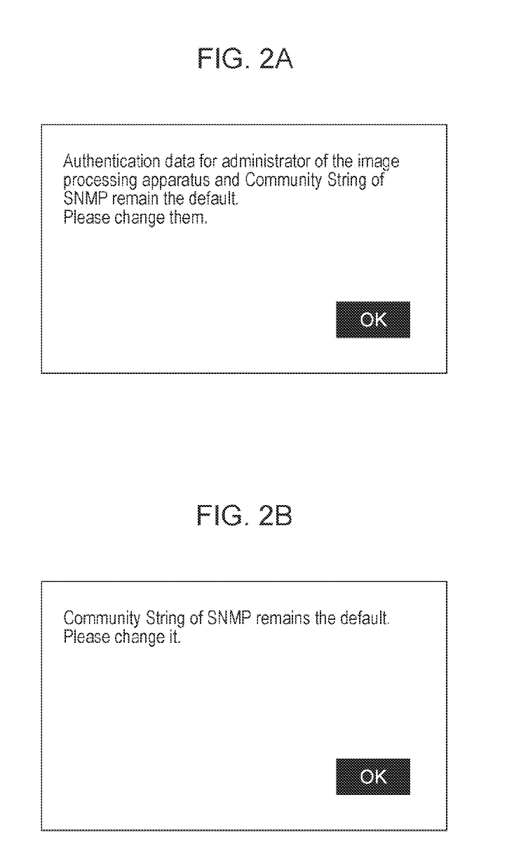

A warning is displayed on the operation panel 15 (hereinafter referred to as a “local panel”). Alternatively, a warning may be displayed in a pop-up manner on the remote UI provided by the EWS. The warning is cancelled upon the pieces of authentication data for administrator of all the remotely accessible interfaces being changed from the default. Further, the warning is displayed such that the authentication data for administrator remaining the default is specified. In a case when there are plural warning items, plural warning screens each including one warning item may be displayed in an overlapped manner, so that the user is allowed to check and close the warning screens one by one, or one warning screen including plural warning items may be displayed, and the content of the warning screen may be changed after the user has changed the authentication data for administrator. FIGS. 2A and 2B illustrate an example of a warning screen including plural warning items. The warning screen illustrated in FIG. 2A includes a warning item indicating that the authentication data for administrator of the image processing apparatus 10 remains the default and a warning item indicating that the authentication data for administrator of the SNMP remains the default. The warning screen illustrated in FIG. 2B is displayed after the authentication data for administrator of the image processing apparatus 10 has been changed from the default, and includes a warning item indicating that the authentication data for administrator of the SNMP remains the default.

Such a warning screen is normally displayed after login of the administrator, that is, after authentication has been successfully performed, because the warning screen gives a hint to an attacker. The warning screen may be displayed at startup of the image processing apparatus 10. In this case, if the warning screen is displayed on the remote UI, it gives a hint to an attacker, and thus the warning screen is displayed on only the local panel.

Here, the warning function may be enabled (ON) or disabled (OFF), and is ON as a default setting. However, the image processing apparatus 10 that is connected to an intranet protected by a firewall may be operated with the authentication data for administrator remaining the default. In this case, the warning function is turned OFF, so that a warning is not displayed even if the authentication data for administrator remains the default.

Further, in the case of displaying a warning screen, communication with an external network may be blocked to enhance the reliability of preventing leakage of information. Specifically, an access from an external network to the image processing apparatus 10, and data transmission from the image processing apparatus 10 to the external network may be blocked. The blockage may be performed for all the communications between the image processing apparatus 10 and the external network, or may be performed for only the communication that is performed using a protocol in which the authentication data for administrator remains the default. For example, in a case when the authentication data for administrator of the EWS is operated as the default, HyperText Transfer Protocol (HTTP) communication for accessing the path of the EWS may be blocked. In a case when the authentication data for administrator of the SNMP (community string) is operated as the default, SNMP communication may be blocked.

Further, for example, even if the authentication data for administrator of the EWS and the authentication data for administrator of the SNMP have been changed from the default, in a case when the same password is set to both the pieces of authentication data for administrator, a warning may be displayed for safety.

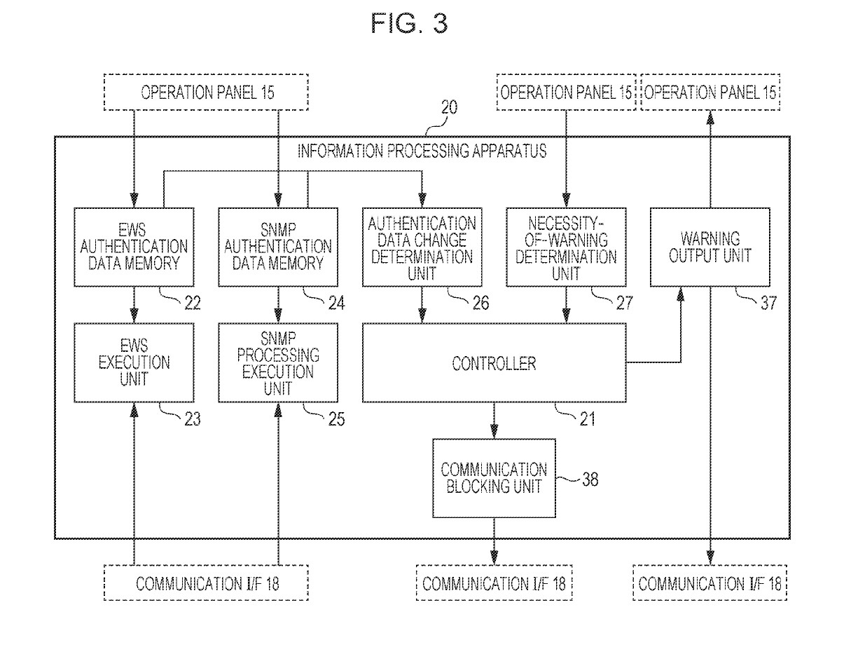

FIG. 3 is a block diagram illustrating an example of the functional configuration of an information processing apparatus 20 that performs the above-described information processing. Here, the information processing apparatus 20 is regarded as an apparatus that is implemented when the CPU 11 (see FIG. 1) of the image processing apparatus 10 loads a program for implementing individual functional units described below from the ROM 13 (see FIG. 1) to the RAM 12 (see FIG. 1) and executes the program.

As illustrated in FIG. 3, the information processing apparatus 20 includes a controller 21, an EWS authentication data memory 22, an EWS execution unit 23, an SNMP authentication data memory 24, an SNMP processing execution unit 25, an authentication data change determination unit 26, a necessity-of-warning determination unit 27, a warning output unit 37, and a communication blocking unit 38.

The controller 21 controls the entire information processing apparatus 20. That is, the controller 21 determines a functional unit to be operated among the plural functional units described below, provides the functional unit with an instruction about an operation, and receives a result.

The EWS authentication data memory 22 stores authentication data for administrator that is to be used for authentication in the remote UI provided by the EWS (hereinafter referred to as “EWS authentication data”). Here, it is assumed that the EWS authentication data is changeable using the local panel, for example.

The EWS execution unit 23 executes the EWS. Specifically, when notified by the communication I/F 18 that a request has come from a personal computer (PC) that is not illustrated, the EWS execution unit 23 instructs the communication I/F 18 to display the remote UI on the PC. When notified by the communication I/F 18 of the EWS authentication data input on the remote UI displayed on the PC, the EWS execution unit 23 performs authentication processing. That is, the EWS execution unit 23 compares the EWS authentication data reported from the communication I/F 18 with the EWS authentication data stored in the EWS authentication data memory 22, and determines whether or not both the pieces of authentication data match each other. In a case when both the pieces of authentication data match each other, the EWS execution unit 23 provides an EWS service.

The SNMP authentication data memory 24 stores authentication data for administrator that is to be used for authentication when an access is made using the SNMP (hereinafter referred to as “SNMP authentication data”). Here, it is assumed that the SNMP authentication data is changeable using the local panel, for example.

The SNMP processing execution unit 25 executes processing using the SNMP. Specifically, when notified by the communication I/F 18 of SNMP authentication data transmitted from a PC or the like (not illustrated), the SNMP processing execution unit 25 executes authentication processing. That is, the SNMP processing execution unit 25 compares the SNMP authentication data reported from the communication I/F 18 with the SNMP authentication data stored in the SNMP authentication data memory 24, and determines whether or not both the pieces of authentication data match each other. As a result, if both the pieces of authentication data match each other, the SNMP processing execution unit 25 transmits information managed by the image processing apparatus 10 using the SNMP, for example.

The authentication data change determination unit 26 determines whether or not both the EWS authentication data stored in the EWS authentication data memory 22 and the SNMP authentication data stored in the SNMP authentication data memory 24 have been changed from the default. In this exemplary embodiment, the EWS and SNMP are used as an example of at least one service in which information held by the own apparatus is provided via a communication unit, EWS authentication data and SNMP authentication data are used as an example of authentication information used for authentication that is performed to utilize at least one service, and the authentication data change determination unit 26 is provided as an example of a determination unit that determines whether or not authentication information has been changed from an initial setting value.

The necessity-of-warning determination unit 27 holds information indicating enable (ON) or disable (OFF) of the warning function, and determines whether or not a warning is to be output with reference to the information. Here, enable (ON) and disable (OFF) of the warning function is settable using the local panel.

The warning output unit 37 outputs a warning to a display device, such as the local panel or the remote UI, so that a warning screen is displayed on the display device. In this exemplary embodiment, the warning output unit 37 is provided as an example of a warning unit that outputs a warning to change authentication information from an initial setting value.

The communication blocking unit 38 instructs the communication I/F 18 to block communication with an external network. Specifically, the communication blocking unit 38 provides an instruction to block an access from the external network to the image processing apparatus 10 and data transmission from the image processing apparatus 10 to the external network.

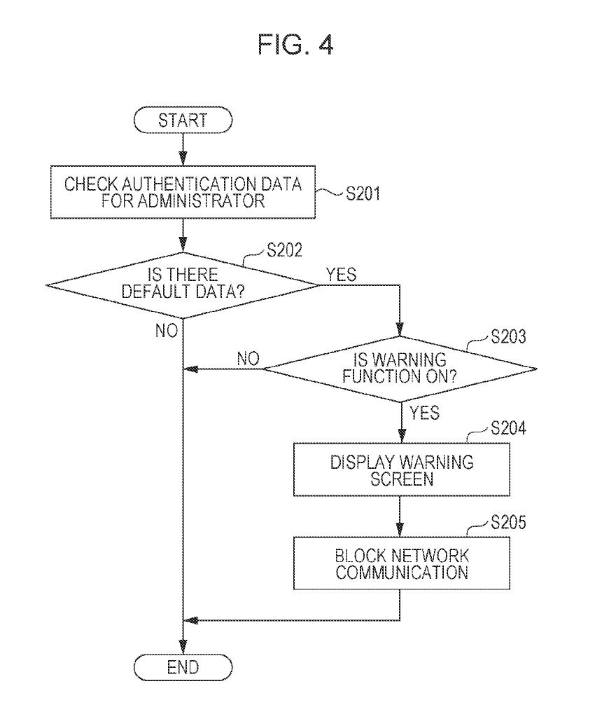

FIG. 4 is a flowchart illustrating an operation example of the information processing apparatus 20 illustrated in FIG. 3. It is assumed that the operation is performed after the administrator has succeeded in authentication using the remote UI of the EWS or authentication that is performed to make an access using the SNMP. As described above, the individual functional units except the controller 21 are operated under control performed by the controller 21, but a description will not be given below of the control performed by the controller 21.

As illustrated in FIG. 4, in the information processing apparatus 20, the authentication data change determination unit 26 checks the authentication data for administrator stored in the EWS authentication data memory 22 (EWS authentication data) and the authentication data for administrator stored in the SNMP authentication data memory 24 (SNMP authentication data) (step S201). Subsequently, the authentication data change determination unit 26 determines whether or not there is data that has not been changed from the default among the EWS authentication data and the SNMP authentication data (step S202).

In a case when the authentication data change determination unit 26 determines that there is not data that has not been changed from the default among the EWS authentication data and the SNMP authentication data, that is, both the EWS authentication data and the SNMP authentication data have been changed from the default, there is no risk of leakage of information caused by use of default authentication data, and thus the process ends without outputting a warning.

On the other hand, in a case when the authentication data change determination unit 26 determines that there is data that has not been changed from the default among the EWS authentication data and the SNMP authentication data, that is, at least one of the EWS authentication data and the SNMP authentication data remains the default, there is a risk of leakage of information caused by use of default authentication data, and thus a process of outputting a warning is performed. That is, the necessity-of-warning determination unit 27 determines whether or not the warning function is enabled (ON) (step S203). In a case when the necessity-of-warning determination unit 27 determines that the warning function is not enabled (ON), that is, the warning function is disabled (OFF), the process ends without outputting a warning. In a case when the necessity-of-warning determination unit 27 determines that the warning function is enabled (ON), the warning output unit 37 outputs a warning so that a warning screen is displayed on the display device that was used when the administrator succeeded in authentication (step S204). Subsequently, the communication blocking unit 38 instructs the communication I/F 18 to block network communication (step S205).

The first exemplary embodiment is based on the assumption that processing using the EWS and SNMP is performed as processing for providing information held by the own apparatus via a communication unit, but the embodiment of the present invention is not limited thereto. Instead of the processing using the EWS and SNMP, or in addition to the processing using the EWS and SNMP, other processing may be performed.

### Second Exemplary Embodiment

In a second exemplary embodiment, a warning is output in a case when the image processing apparatus 10 is connected to an external network via a global IP address (it may be simply referred to as a “global IP”).

In a case when an IP address obtained by the image processing apparatus 10 using a dynamic host configuration protocol (DHCP) is a global IP address, and in a case when the administrator sets a global IP address as the IP address of the image processing apparatus 10, it is determined that there is a high possibility that the image processing apparatus 10 is connected to a network accessible from the outside. Even if the IP address of the image processing apparatus 10 is a global IP address, in a case when information for identifying a proxy server has been set (hereinafter referred to as a “proxy setting”), it is determined that the image processing apparatus 10 is within a network protected by a firewall.

Accordingly, in the second embodiment, the operation according to the first exemplary embodiment is performed in a case when it is determined that there is a high possibility that the image processing apparatus 10 is connected to a network accessible from the outside, for example, because the IP address of the image processing apparatus 10 is a global IP address. That is, it is determined whether or not the authentication data for administrator has been changed from the default, and a warning is output if the data has not been changed.

Also, in the second exemplary embodiment, in a case when it is determined that there is a high possibility that the image processing apparatus 10 is connected to a network accessible from the outside, for example, because the IP address of the image processing apparatus 10 is a global IP address, it is determined whether or not a setting for performing authentication with respect to an access from the outside has been performed (an authentication setting is ON). In a case when a setting for performing authentication with respect to an access from the outside has not been performed (an authentication setting is OFF), it is determined that a risk of the occurrence of leakage of information caused by an access from the outside is high, and a warning is displayed to change the authentication setting. For example, in a case when any one of “local authentication” in which authentication data registered in the image processing apparatus 10 is used, “network authentication” in which an authentication server in a network is used, and “no authentication” is settable as an authentication scheme for the image processing apparatus 10, it may be determined that the authentication setting is ON when the authentication scheme is “local authentication” or “network authentication”. In this case, authentication is performed for an access from the local panel and an access from the outside.

A warning is displayed on the local panel. The warning is cancelled upon change of the setting of performing authentication (the authentication setting is ON). Further, in a case when there are plural warning items, plural warning screens each including one warning item may be displayed in an overlapped manner so that the user is allowed to check and close the warning screens one by one, or one warning screen including plural warning items may be displayed, and the content of the warning screen may be changed after the user has changed the authentication setting. In a case when plural settings are necessary to cancel a warning, warning screens the number of which corresponds to the number of cancellation methods for one warning may be displayed in an overlapped manner, or one warning and plural settings that are necessary for cancellation may be displayed on one warning screen.

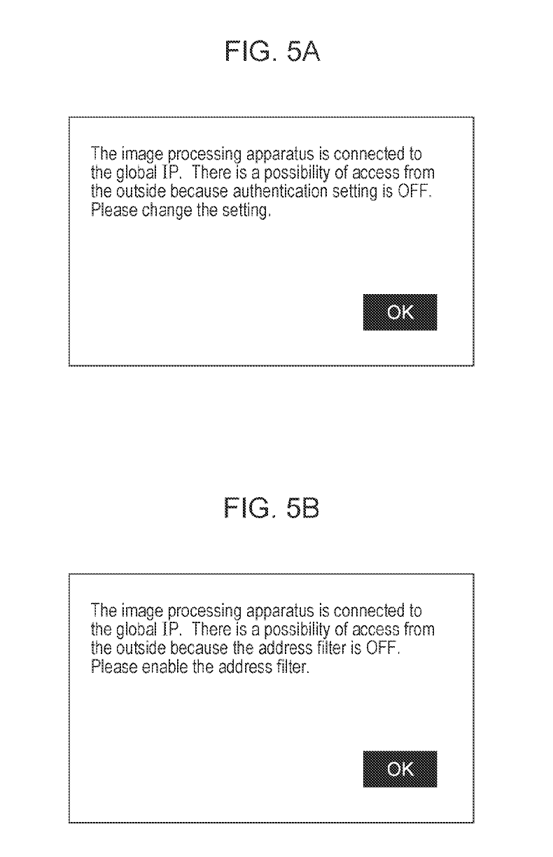

FIGS. 5A and 5B illustrate an example of a case where plural warning screens are displayed in a case when plural cancellation settings are necessary for one warning. For a warning indicating that the IP address of the image processing apparatus 10 is a global IP address, two cancellation settings are necessary: the authentication setting is turned ON and an address filter is turned ON. The warning screen illustrated in FIG. 5A displays a warning item indicating that the IP address of the image processing apparatus 10 is a global IP address and a message indicating that the authentication setting is to be turned ON to cancel this. The warning screen illustrated in FIG. 5B displays a warning item indicating that the IP address of the image processing apparatus 10 is a global IP address and a message indicating that the address filter is to be turned ON to cancel this. As a result of turning on the authentication setting and turning on the address filter, all the warning screens disappear. In a case when only the authentication setting is turned on, only the warning screen illustrated in FIG. 5A disappears, and the warning screen illustrated in FIG. 5B remains.

Further, in the second exemplary embodiment, in a case when it is determined that there is a high possibility that the image processing apparatus 10 is connected to a network accessible from the outside, because the IP address of the image processing apparatus 10 is an global IP address, for example, it is determined whether or not the address filter setting is ON so that access control may be performed by distinguishing an access from the outside and an access within the organization from each other. In a case when the address filter setting is OFF, it is determined that there is a high risk of the occurrence of leakage of information due to an access from the outside, and a warning is displayed to change the address filter setting.

Here, an IP address filter or a MAC address filter may be set as an address filter. Specifically, a permission list or prohibition list may be set, and addresses of terminals for which an access is permitted or prohibited or the range of addresses may be set.

A warning is displayed on the local panel. Alternatively, a warning may be displayed on the remote UI based on the EWS in a pop-up manner. The warning is cancelled upon turning on of the address filter setting. Further, in a case when there are plural warning items, plural warning screens each including one warning item may be displayed in an overlapped manner, so that the user is allowed to check and close the warning screens one by one, or one warning screen including plural warning items may be displayed, and the content of the warning screen may be changed after the user has changed the address filter setting. FIG. 5B illustrates an example of a warning screen including plural warning items. This warning screen includes a warning item indicating that the IP address of the image processing apparatus 10 is a global IP address and a warning item indicating that the address filter setting is OFF. On this warning screen, if the address filter setting is turned ON, not only the latter warning item but also the former warning item disappears, and the entire screen disappears.

Normally, a warning screen is displayed when the administrator logs in. However, in a case when the authentication setting is OFF, there is no timing to output a warning. In this case, a warning screen may be displayed, for example, at startup of the image processing apparatus 10. Alternatively, since the image processing apparatus 10 may be continuously operated for 24 hours, a warning screen may be displayed at a predetermined interval after startup of the image processing apparatus 10. In a case when a warning screen is displayed at timing other than login of the administrator (in a case when a warning screen is displayed at startup of the image processing apparatus 10 or at a predetermined interval), if the warning screen is displayed on the remote UI of the EWS or the like, a hint is given to an attacker, and thus the warning screen is displayed on only the local panel. Regarding a remote access, in a case when a subnet mask is set for a remote access, a warning screen is displayed for only an access within a subnet, that is, an access within an organization. On the other hand, an access from the outside of the subnet is regarded as an access from the outside of the organization, and a warning screen is not displayed. In this way, display/non-display of a warning message is switched in accordance with whether the access source is within or outside the subnet.

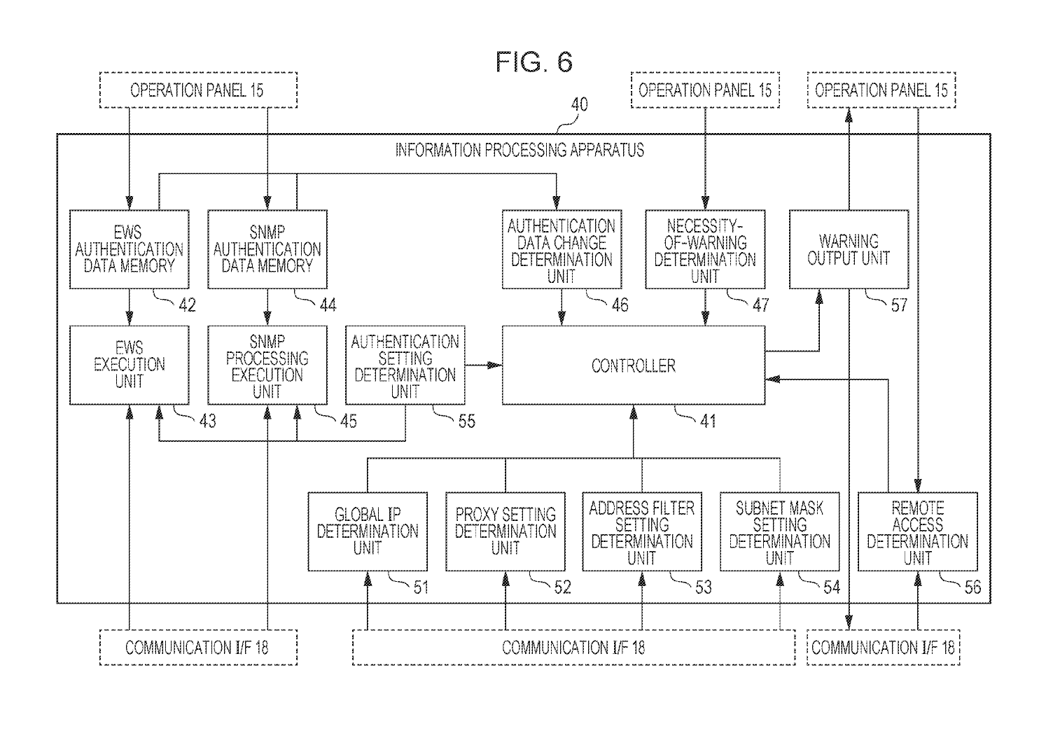

FIG. 6 is a block diagram illustrating an example of the functional configuration of an information processing apparatus 40 that performs the above-described information processing. Here, the information processing apparatus 40 is regarded as an apparatus that is implemented when the CPU 11 (see FIG. 1) of the image processing apparatus 10 loads a program for implementing individual functional units described below from the ROM 13 (see FIG. 1) to the RAM 12 (see FIG. 1) and executes the program.

As illustrated in FIG. 6, the information processing apparatus 40 includes a controller 41, an EWS authentication data memory 42, an EWS execution unit 43, an SNMP authentication data memory 44, an SNMP processing execution unit 45, an authentication data change determination unit 46, and a necessity-of-warning determination unit 47. Also, the information processing apparatus 40 includes a global IP determination unit 51, a proxy setting determination unit 52, an address filter setting determination unit 53, a subnet mask setting determination unit 54, an authentication setting determination unit 55, a remote access determination unit 56, and a warning output unit 57.

The controller 41 controls the entire information processing apparatus 40. That is, the controller 41 determines a functional unit to be operated among plural functional units described below, provides the functional unit with an instruction about an operation, and receives a result.

The EWS authentication data memory 42, the EWS execution unit 43, the SNMP authentication data memory 44, and the SNMP processing execution unit 45 have the same functions as those of the EWS authentication data memory 22, the EWS execution unit 23, the SNMP authentication data memory 24, and the SNMP processing execution unit 25 according to the first exemplary embodiment, respectively, and thus the description thereof is omitted.

Also, the authentication data change determination unit 46 has the same function as that of the authentication data change determination unit 26 according to the first exemplary embodiment, and thus the description thereof is omitted. In the second exemplary embodiment, the authentication data change determination unit 46 is provided as an example of a state determination unit that determines whether or not a current state is a state where leakage of information held by the own apparatus may occur. Further, the authentication data change determination unit 46 is provided also as an example of a state determination unit that determines whether or not the state of the own apparatus is a state where the authentication information has not been changed from an initial setting value.

Also, the necessity-of-warning determination unit 47 has the same function as that of the necessity-of-warning determination unit 27 according to the first exemplary embodiment, and thus the description thereof is omitted.

The global IP determination unit 51 determines whether or not an IP address obtained by the image processing apparatus 10 using the DHCP or an IP address set for the image processing apparatus 10 by the administrator is a global IP address, with reference to the setting information of the communication I/F 18. In this exemplary embodiment, the global IP determination unit 51 is provided as an example of an IP address determination unit that determines whether or not the IP address of the own apparatus is a global IP address.

The proxy setting determination unit 52 determines whether or not a proxy setting has been performed on the image processing apparatus 10, with reference to the setting information of the communication I/F 18. In this exemplary embodiment, the proxy setting determination unit 52 is provided as an example of an identification information determination unit that determines whether or not identification information for identifying a proxy server is set for the own apparatus.

The address filter setting determination unit 53 determines whether or not the address filter setting of the image processing apparatus 10 is ON, with reference to the setting information of the communication I/F 18. In this exemplary embodiment, the address filter setting determination unit 53 is provided as an example of a state determination unit that determines whether or not a current state is a state where leakage of information held by the own apparatus may occur. Also, an address filter is used as an example of a function of selecting another apparatus capable of communicating with the own apparatus via a communication unit, and the address filter setting determination unit 53 is provided also as an example of a state determination unit that determines whether or not the own apparatus is in a state where the function is disabled.

The subnet mask setting determination unit 54 determines whether or not a remote access is an access within a subnet or outside the subnet, with reference to the setting information of the communication I/F 18 (setting of the subnet mask).

The authentication setting determination unit 55 determines whether or not the authentication setting of the image processing apparatus 10 is ON, with reference to a storage area in which a predetermined authentication setting is stored. In this exemplary embodiment, the authentication setting determination unit 55 is provided as an example of a state determination unit that determines whether or not a current state is a state where leakage of information held by the own apparatus may occur. Also, the authentication setting determination unit 55 is provided also as an example of a state determination unit that determines whether or not the own apparatus is in a state where the function of performing authentication is disabled.

The remote access determination unit 56 monitors information from the local panel and information from the communication I/F 18, and determines whether or not received information has been transmitted via a remote access.

The warning output unit 57 outputs a warning to a display device such as the local panel or the remote UI so that a warning screen is displayed on the display device. At this time, if the warning screen is displayed when the administrator performs authentication, a warning is output to the display device so that the warning screen is displayed on the display device only in the case of (1) an access that is not a remote access, and (2) a remote access within a subnet. Specifically, in case (1), a warning is output so that the warning screen is displayed on the local panel. In case (2), a warning is output so that the warning screen is displayed on the remote UI. In this exemplary embodiment, the warning output unit 57 is provided as an example of a warning unit that outputs a warning to change the state of the own apparatus.

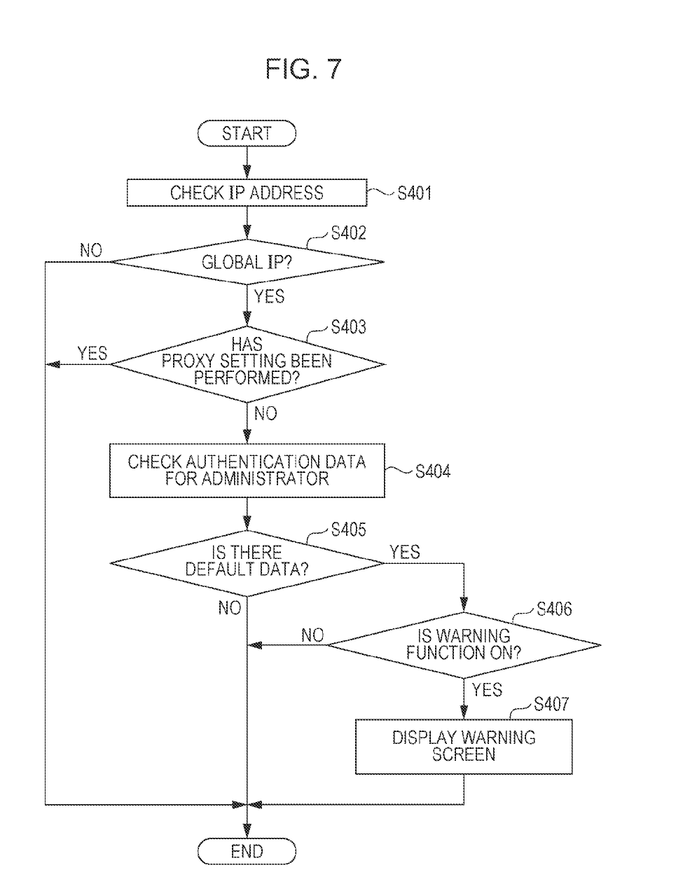

FIG. 7 is a flowchart illustrating a first operation example of the information processing apparatus 40 illustrated in FIG. 6. More specifically, FIG. 7 illustrates an operation in which a warning is output in a case when the authentication data for administrator has not been changed from the default. It is assumed that the operation is performed after authentication of the administrator has successfully been performed. As described above, the individual functional units except the controller 41 are operated under control performed by the controller 41, but a description will not be given below of the control performed by the controller 41.

As illustrated in FIG. 7, in the information processing apparatus 40, the global IP determination unit 51 checks the IP address of the image processing apparatus 10 (step S401). Subsequently, the global IP determination unit 51 determines whether or not the IP address of the image processing apparatus 10 is a global IP (step S402). In a case when the global IP determination unit 51 determines that the IP address of the image processing apparatus 10 is not a global IP, it is determined that there is a low possibility that the image processing apparatus 10 is connected to a network accessible from the outside, and thus the process ends without outputting a warning. In a case when the global IP determination unit 51 determines that the IP address of the image processing apparatus 10 is a global IP, the proxy setting determination unit 52 determines whether or not a proxy setting has been performed on the image processing apparatus 10 (step S403).

In a case when the proxy setting determination unit 52 determines that a proxy setting has been performed on the image processing apparatus 10, it is determined that there is a high possibility that the image processing apparatus 10 is within a network protected by a firewall, and thus the process ends without outputting a warning. In a case when the proxy setting determination unit 52 determines that a proxy setting has not been performed on the image processing apparatus 10, it is determined that there is a high possibility that the image processing apparatus 10 is connected to a network accessible from the outside, and that there is a low possibility that the image processing apparatus 10 is within a network protected by a firewall. In this case, the process described in the first exemplary embodiment is performed.

That is, the authentication data change determination unit 46 checks the authentication data for administrator stored in the EWS authentication data memory 42 (EWS authentication data) and the authentication data for administrator stored in the SNMP authentication data memory 44 (SNMP authentication data) (step S404). Subsequently, the authentication data change determination unit 46 determines whether or not there is data that has not been changed from the default among the EWS authentication data and the SNMP authentication data (step S405).

In a case when the authentication data change determination unit 46 determines that there is not data that has not been changed from the default among the EWS authentication data and the SNMP authentication data, that is, both the EWS authentication data and the SNMP authentication data have been changed from the default, there is no risk of leakage of information caused by use of default authentication data, and thus the process ends without outputting a warning.

On the other hand, in a case when the authentication data change determination unit 46 determines that there is data that has not been changed from the default among the EWS authentication data and the SNMP authentication data, that is, at least one of the EWS authentication data and the SNMP authentication data remains the default, there is a risk of leakage of information caused by use of default authentication data, and thus a process of outputting a warning is performed. That is, the necessity-of-warning determination unit 47 determines whether or not the warning function is enabled (ON) (step S406). In a case when the necessity-of-warning determination unit 47 determines that the warning function is not enabled (ON), that is, the warning function is disabled (OFF), the process ends without outputting a warning. In a case when the necessity-of-warning determination unit 47 determines that the warning function is enabled (ON), the warning output unit 57 outputs a warning so that a warning screen is displayed on the display device that was used when the administrator succeeded in authentication (step S407).

In this operation example, it is determined in step S403 whether or not a proxy setting has been performed on the image processing apparatus 10, but this determination is not necessarily performed.

Also, in this operation example, network communication is not blocked when a warning is output in step S407, but the network communication may be blocked as in the first exemplary embodiment.

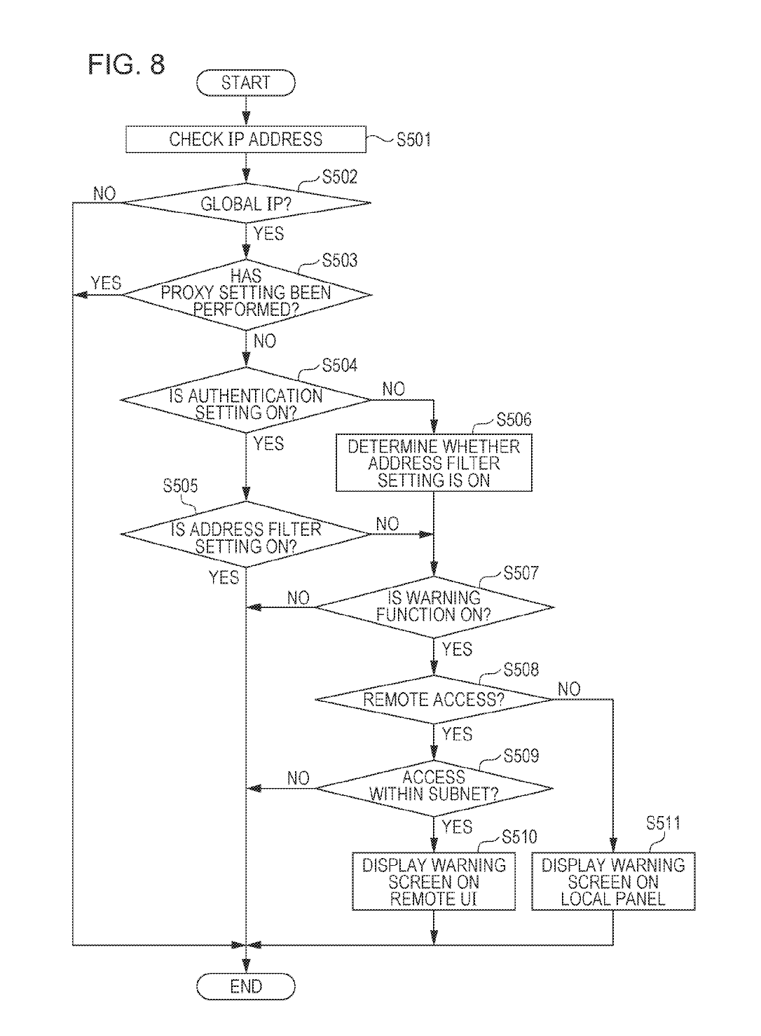

FIG. 8 is a flowchart illustrating a second operation example of the information processing apparatus 40 illustrated in FIG. 6. More specifically, FIG. 8 illustrates operation in which a warning is output in a case when the authentication setting is OFF or in a case when the address filter setting is OFF. It is assumed that the operation is performed at certain timing at which the administrator has not been authenticated (for example, timing at which the image processing apparatus 10 is started, timing at which a predetermined time period has elapsed, or timing at which a remote access is made). As described above, the individual functional units except the controller 41 are operated under control performed by the controller 41, but a description will not be given below of the control performed by the controller 41.

As illustrated in FIG. 8, in the information processing apparatus 40, the global IP determination unit 51 checks the IP address of the image processing apparatus 10 (step S501). Subsequently, the global IP determination unit 51 determines whether or not the IP address of the image processing apparatus 10 is a global IP (step S502). In a case when the global IP determination unit 51 determines that the IP address of the image processing apparatus 10 is not a global IP, it is determined that there is a low possibility that the image processing apparatus 10 is connected to a network accessible from the outside, and thus the process ends without outputting a warning. In a case when the global IP determination unit 51 determines that the IP address of the image processing apparatus 10 is a global IP, the proxy setting determination unit 52 determines whether or not a proxy setting has been performed on the image processing apparatus 10 (step S503).

In a case when the proxy setting determination unit 52 determines that a proxy setting has been performed on the image processing apparatus 10, it is determined that there is a high possibility that the image processing apparatus 10 is within a network protected by a firewall, and thus the process ends without outputting a warning. In a case when the proxy setting determination unit 52 determines that a proxy setting has not been performed on the image processing apparatus 10, it is determined that there is a high possibility that the image processing apparatus 10 is connected to a network accessible from the outside, and that there is a low possibility that the image processing apparatus 10 is within a network protected by a firewall. Thus, it is determined whether or not a setting that may cause leakage of information has been performed, and if such a setting has been performed, a warning is output.

Specifically, the authentication setting determination unit 55 determines whether or not the authentication setting of the image processing apparatus 10 is ON (step S504). In a case when the authentication setting determination unit 55 determines that the authentication setting of the image processing apparatus 10 is ON, the address filter setting determination unit 53 determines whether or not the address filter setting of the image processing apparatus 10 is ON (step S505). In a case when the address filter setting determination unit 53 determines that the address filter setting of the image processing apparatus 10 is ON, there is a low risk that the apparatus will be accessed from the outside without authentication being performed or that the apparatus will be accessed from another apparatus having an address for which connection is to be prohibited, and thus the process ends without outputting a warning.

On the other hand, in a case when the authentication setting determination unit 55 determines that the authentication setting of the image processing apparatus 10 is OFF, and that the address filter setting of the image processing apparatus 10 is OFF, there is a high risk that the apparatus will be accessed from the outside without authentication being performed or that the apparatus will be accessed from another apparatus having an address for which connection is to be prohibited, and thus a process of outputting a warning is performed. That is, in a case when it is determined in step S504 that the authentication setting of the image processing apparatus 10 is OFF, the address filter setting determination unit 53 determines whether or not the address filter setting of the image processing apparatus 10 is ON (step S506), and then the necessity-of-warning determination unit 47 determines whether or not the warning function is enabled (ON) (step S507). In a case when the necessity-of-warning determination unit 47 determines that the warning function is not enabled (ON), that is, the warning function is disabled (OFF), the process ends without outputting a warning. In a case when the necessity-of-warning determination unit 47 determines that the warning function is enabled (ON), the remote access determination unit 56 determines whether or not this operation is performed through a remote access (step S508).

In a case when the remote access determination unit 56 determines that this operation is performed through a remote access, the subnet mask setting determination unit 54 determines whether or not the remote access is an access within a subnet (step S509). In a case when the subnet mask setting determination unit 54 determines that the remote access is not an access within the subnet, it is determined that the remote access is an access from the outside of the organization, and thus the process ends without outputting a warning. In a case when the subnet mask setting determination unit 54 determines that the remote access is an access within the subnet, it is determined that the remote access is an access within the organization, and thus the warning output unit 57 outputs a warning so that a warning screen is displayed on the remote UI (step S510).

On the other hand, in a case when it is determined in step S508 that the operation is not performed through a remote access, the warning output unit 57 outputs a warning so that a warning screen is displayed on the local panel (step S511).

On the warning screen displayed in step S510 or S511, a cancellation condition based on the results of determination performed in steps S504 to S506 is displayed.

In this operation example, it is determined in step S503 whether or not a proxy setting has been performed on the image processing apparatus 10, but this determination is not necessarily performed. In that case, however, this determination may be performed in a case when it is determined in step S508 that this operation is performed through a remote access. In a case when it is determined that a proxy setting has been performed on the image processing apparatus 10, it is determined that the remote access is an access within a network protected by a firewall, and thus the process proceeds to step S510, where the warning output unit 57 may output a warning so that a warning screen is displayed on the remote UI. In a case when it is determined that a proxy setting has not been performed on the image processing apparatus 10, the process proceeds to step S509, where the subnet mask setting determination unit 54 may determine whether or not the remote access is an access within the subnet.

Also, in this operation example, it is determined in step S504 whether or not the authentication setting is ON, and it is determined in step S505 whether or not the address filter setting is ON, and a warning is output if at least any one of the settings is OFF. However, the embodiment of the present invention is not limited thereto. Only one of the determination in step S504 and the determination in step S505 may be performed, and a warning may be output if the determination indicates that the setting is OFF.

The second exemplary embodiment is based on the assumption that processing using the EWS and SNMP is performed as processing for providing information held by the own apparatus via a communication unit, but the embodiment of the present invention is not limited thereto. Instead of the processing using the EWS and SNMP, or in addition to the processing using the EWS and SNMP, other processing may be performed.

Also, in the second exemplary embodiment, both the first operation example and the second operation example are performed, but only one of the first operation example and the second operation example may be performed. In a case when only the first operation example is performed, the example of the functional configuration of the information processing apparatus 40 may include only the parts related to the first operation example. In a case when only the second operation example is performed, the example of the functional configuration of the information processing apparatus 40 may include only the parts related to the second operation example.

Further, in the first operation example, as in the second operation example, the UI on which a warning screen is displayed may be changed in accordance with determination about a remote access and determination about an access within the subnet.

Further, in the second exemplary embodiment, a state where the authentication data for administrator has not been changed from the default, a state where the authentication setting is OFF, and a state where the address filter setting is OFF are assumed as a state where leakage of information held by the own apparatus may occur, but another state may also be assumed.

### Third Exemplary Embodiment

In a third exemplary embodiment, a security setting is changed in a case when the image processing apparatus 10 is connected to an external network using a global IP address.

In a case when an IP address obtained by the image processing apparatus 10 using the DHCP is a global IP address, and in a case when the administrator sets a global IP address as the IP address of the image processing apparatus 10, it is determined that there is a high possibility that the image processing apparatus 10 is connected to a network accessible from the outside. Even if the IP address of the image processing apparatus 10 is a global IP address, in a case when a proxy setting has been performed on the image processing apparatus 10, it is determined that the image processing apparatus 10 is within a network protected by a firewall.

In the third exemplary embodiment, in a case when it is determined that there is a high possibility that the image processing apparatus 10 is connected to a network accessible from the outside because the IP address of the image processing apparatus 10 is a global IP address, the security setting of the image processing apparatus 10 is changed, so as to reduce a risk of leakage of information.

Examples of a process of changing the security setting are as follows.

(1) Process of changing setting of protocol

This is a process of changing the version of SNMP from V2 to V3, or a process of enabling cryptographic communication such as secure sockets layer (SSL) so that communication may be performed more safely.

(2) Process of generating password of administrator

This is a process of generating a password of the administrator from the serial number of the image processing apparatus 10 or time information, and printing out the details of change of setting including the generated password, or transmitting the details to a preset mail address of the administrator, thereby preventing an unauthorized access using a default password. Alternatively, a process of generating a user ID of the administrator in the same manner as the password may be performed.

(3) Process of setting the number of authentication failures that result in authentication lock

This is a process of changing the number of authentication failures that result in authentication lock in a case when there is a function of locking authentication if the administrator repeats authentication failure a predetermined number of times. Here, authentication lock is a function of temporarily stopping authentication. For example, in a case when the IP address of the image processing apparatus 10 is a private IP address, authentication lock does not occur until the administrator fails in authentication ten times. On the other hand, in a case when the IP address of the image processing apparatus 10 is a global IP address, authentication lock occurs if the administrator fails in authentication five times. Here, authentication lock is a function of locking authentication if authentication failure occurs a certain number of times, and is a function of preventing an unauthorized access. Authentication lock is released by OFF/ON of the power of the image processing apparatus 10.

(4) Process of setting IP address filter

This is a process of changing the setting of an IP address filter so that an access within a subnet is permitted and an access from an address outside the subnet is not permitted on the basis of the subnet mask setting of the image processing apparatus 10.

(5) Blocking of communication

This is a process of blocking an access from an external network to the image processing apparatus 10 and data transmission from the image processing apparatus 10 to the external network.

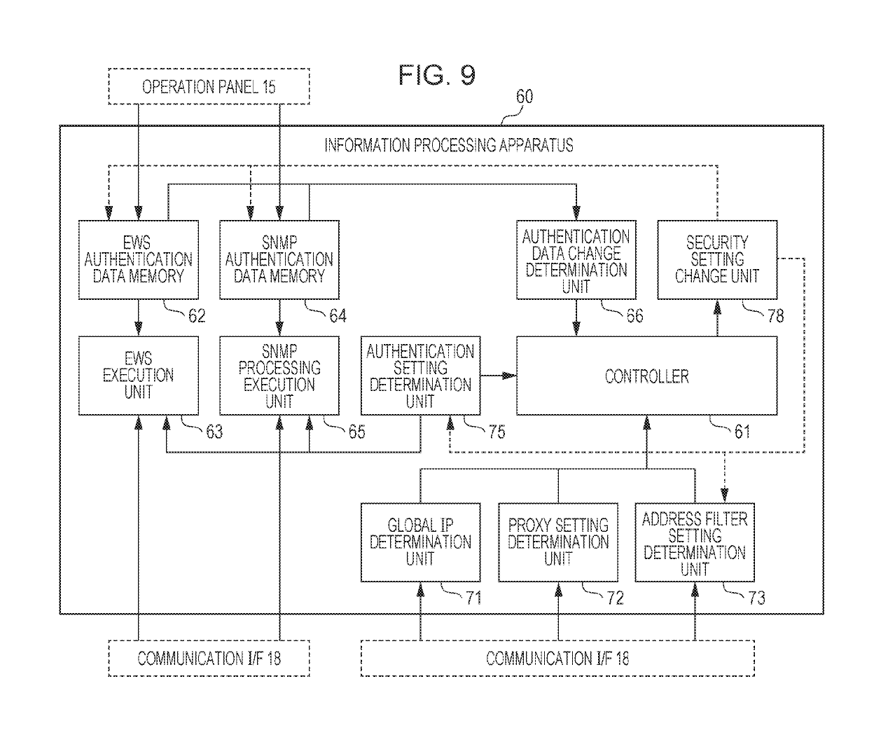

FIG. 9 is a block diagram illustrating an example of the functional configuration of an information processing apparatus 60 that performs the above-described information processing. Here, the information processing apparatus 60 is regarded as an apparatus that is implemented when the CPU 11 (see FIG. 1) of the image processing apparatus 10 loads a program for implementing individual functional units described below from the ROM 13 (see FIG. 1) to the RAM 12 (see FIG. 1) and executes the program.

As illustrated in FIG. 9, the information processing apparatus 60 includes a controller 61, an EWS authentication data memory 62, an EWS execution unit 63, an SNMP authentication data memory 64, an SNMP processing execution unit 65, and an authentication data change determination unit 66. Also, the information processing apparatus 60 includes a global IP determination unit 71, a proxy setting determination unit 72, an address filter setting determination unit 73, an authentication setting determination unit 75, and a security setting change unit 78.

The controller 61 controls the entire information processing apparatus 60. That is, the controller 61 determines a functional unit to be operated among plural functional units described below, provides the functional unit with an instruction about an operation, and receives a result.

The EWS authentication data memory 62, the EWS execution unit 63, the SNMP authentication data memory 64, the SNMP processing execution unit 65, and the authentication data change determination unit 66 have the same functions as those of the EWS authentication data memory 42, the EWS execution unit 43, the SNMP authentication data memory 44, the SNMP processing execution unit 45, and the authentication data change determination unit 46 according to the second exemplary embodiment, respectively, and thus the description thereof is omitted.

Also, the global IP determination unit 71, the proxy setting determination unit 72, the address filter setting determination unit 73, and the authentication setting determination unit 75 have the same functions as those of the global IP determination unit 51, the proxy setting determination unit 52, the address filter setting determination unit 53, and the authentication setting determination unit 55 according to the second exemplary embodiment, respectively, and thus the description thereof is omitted.

The security setting change unit 78 changes various security settings of the image processing apparatus 10. Specifically, the security setting change unit 78 performs the above-described processes (1) to (5). In this exemplary embodiment, the security setting change unit 78 is provided as an example of a change unit that changes the state of the own apparatus. For example, in the process (2), authentication data for administrator is generated from the serial number of the image processing apparatus 10 or time information, and the administrator is notified of the generated authentication data for administrator. From this viewpoint, in this exemplary embodiment, the security setting change unit 78 is provided as an example of a generation unit that generates a new value of authentication information. Also, for example, in the process (3), a setting in which authentication is locked as a result of ten continuous authentication failures is changed to a setting in which authentication is locked as a result of five continuous authentication failures.

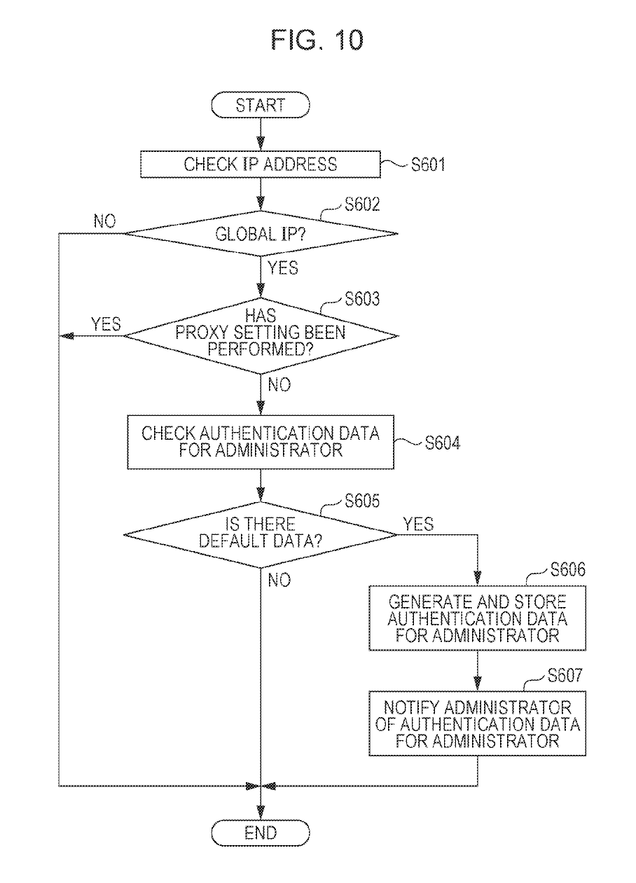

FIG. 10 is a flowchart illustrating a first operation example of the information processing apparatus 60 illustrated in FIG. 9. More specifically, FIG. 10 illustrates an operation in which authentication data for administrator is changed in a case when the authentication data for administrator has not been changed from the default. It is assumed that the operation is performed after authentication of the administrator has successfully been performed. As described above, the individual functional units except the controller 61 are operated under control performed by the controller 61, but a description will not be given below of the control performed by the controller 61.

As illustrated in FIG. 10, in the information processing apparatus 60, the global IP determination unit 71 checks the IP address of the image processing apparatus 10 (step S601). Subsequently, the global IP determination unit 71 determines whether or not the IP address of the image processing apparatus 10 is a global IP (step S602). In a case when the global IP determination unit 71 determines that the IP address of the image processing apparatus 10 is not a global IP, it is determined that there is a low possibility that the image processing apparatus 10 is connected to a network accessible from the outside, and thus the process ends without changing the authentication data for administrator. In a case when the global IP determination unit 71 determines that the IP address of the image processing apparatus 10 is a global IP, the proxy setting determination unit 72 determines whether or not a proxy setting has been performed on the image processing apparatus 10 (step S603).

In a case when the proxy setting determination unit 72 determines that a proxy setting has been performed on the image processing apparatus 10, it is determined that there is a high possibility that the image processing apparatus 10 is within a network protected by a firewall, and thus the process ends without changing the authentication data for administrator. In a case when the proxy setting determination unit 72 determines that a proxy setting has not been performed on the image processing apparatus 10, it is determined that there is a high possibility that the image processing apparatus 10 is connected to a network accessible from the outside, and that there is a low possibility that the image processing apparatus 10 is within a network protected by a firewall. In this case, it is determined whether or not the authentication data for administrator remains the default, and in a case when the authentication data for administrator remain the default, the authentication data for administrator is changed.

That is, the authentication data change determination unit 66 checks the authentication data for administrator stored in the EWS authentication data memory 62 (EWS authentication data) and the authentication data for administrator stored in the SNMP authentication data memory 64 (SNMP authentication data) (step S604). Subsequently, the authentication data change determination unit 66 determines whether or not there is data that has not been changed from the default among the EWS authentication data and the SNMP authentication data (step S605).

In a case when the authentication data change determination unit 66 determines that there is not data that has not been changed from the default among the EWS authentication data and the SNMP authentication data, that is, both the EWS authentication data and the SNMP authentication data have been changed from the default, there is no risk of leakage of information caused by use of default authentication data, and thus the process ends without changing the authentication data for administrator.

On the other hand, in a case when the authentication data change determination unit 66 determines that there is data that has not been changed from the default among the EWS authentication data and the SNMP authentication data, that is, at least one of the EWS authentication data and the SNMP authentication data remains the default, there is a risk of leakage of information caused by use of default authentication data, and thus the security setting changing unit 78 generates new authentication data for administrator for the authentication data that remains default among the EWS authentication data and the SNMP authentication data, and stores the generated authentication data for administrator in the corresponding memory among the EWS authentication data memory 62 and the SNMP authentication data memory 64 (step S606). Subsequently, the security setting change unit 78 notifies the administrator of the generated authentication data for administrator via a print medium or an electronic mail (step S607).

In this operation example, it is determined in step S603 whether or not a proxy setting has been performed on the image processing apparatus 10, but this determination is not necessarily performed.

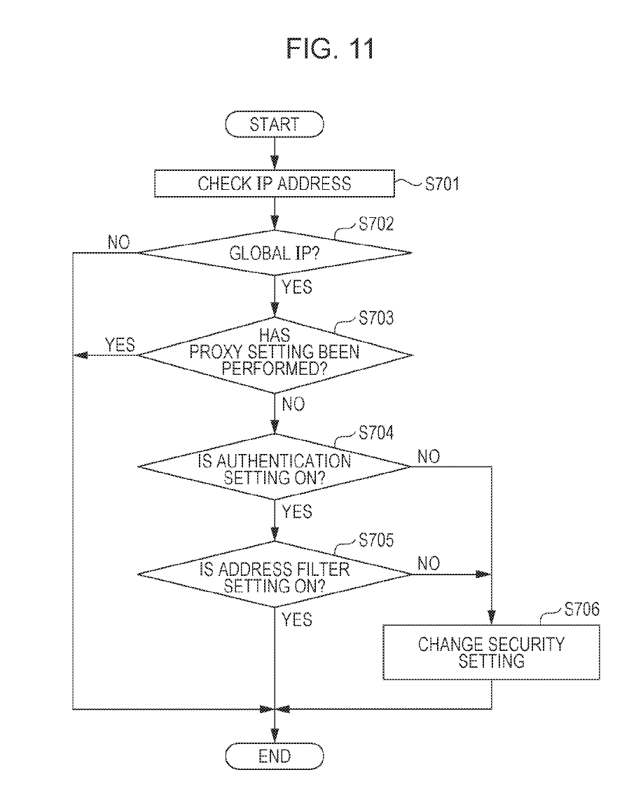

FIG. 11 is a flowchart illustrating a second operation example of the information processing apparatus 60 illustrated in FIG. 9. More specifically, FIG. 11 illustrates operation in which a setting is changed in a case when the authentication setting is OFF or in a case when the address filter setting is OFF. It is assumed that the operation is performed at certain timing at which the administrator has not been authenticated (for example, timing at which the image processing apparatus 10 is started, timing at which a predetermined time period has elapsed, or timing at which a remote access is made). As described above, the individual functional units except the controller 61 are operated under control performed by the controller 61, but a description will not be given below of the control performed by the controller 61.

As illustrated in FIG. 11, in the information processing apparatus 60, the global IP determination unit 71 checks the IP address of the image processing apparatus 10 (step S701). Subsequently, the global IP determination unit 71 determines whether or not the IP address of the image processing apparatus 10 is a global IP (step S702). In a case when the global IP determination unit 71 determines that the IP address of the image processing apparatus 10 is not a global IP, it is determined that there is a low possibility that the image processing apparatus 10 is connected to a network accessible from the outside, and thus the process ends without changing the setting. In a case when the global IP determination unit 71 determines that the IP address of the image processing apparatus 10 is a global IP, the proxy setting determination unit 72 determines whether or not a proxy setting has been performed on the image processing apparatus 10 (step S703).

In a case when the proxy setting determination unit 72 determines that a proxy setting has been performed on the image processing apparatus 10, it is determined that there is a high possibility that the image processing apparatus 10 is within a network protected by a firewall, and thus the process ends without changing the setting. In a case when the proxy setting determination unit 72 determines that a proxy setting has not been performed on the image processing apparatus 10, it is determined that there is a high possibility that the image processing apparatus 10 is connected to a network accessible from the outside, and that there is a low possibility that the image processing apparatus 10 is within a network protected by a firewall. Thus, it is determined whether or not a setting that may cause leakage of information has been performed, and in a case when such a setting has been performed, the setting is changed.

Specifically, the authentication setting determination unit 75 determines whether or not the authentication setting of the image processing apparatus 10 is ON (step S704). In a case when the authentication setting determination unit 75 determines that the authentication setting of the image processing apparatus 10 is ON, the address filter setting determination unit 73 determines whether or not the address filter setting of the image processing apparatus 10 is ON (step S705). In a case when the address filter setting determination unit 73 determines that the address filter setting of the image processing apparatus 10 is ON, there is a low risk that the apparatus will be accessed from the outside without authentication being performed or that the apparatus will be accessed from another apparatus having an address for which connection is to be prohibited, and thus the process ends without changing the setting.

On the other hand, in a case when it is determined that the authentication setting of the image processing apparatus 10 is OFF, and in a case when it is determined that the address filter setting of the image processing apparatus 10 is OFF, there is a high risk that the apparatus will be accessed from the outside without authentication being performed or that the apparatus will be accessed from another apparatus having an address for which connection is to be prohibited, and thus the security setting change unit 78 changes the security setting (step S706). Specifically, in a case when the authentication setting is OFF, the security setting change unit 78 turns ON the authentication setting. In a case when the address filter setting is OFF, the security setting changing unit 78 turns ON the address filter setting. More specifically, the latter is performed through a process of changing the setting of the IP address filter so that an access within the subnet is permitted and an access from an address outside the subnet is not permitted. Alternatively, although not illustrated in the flowchart, both of the authentication setting and the address filter setting may be turned ON in a case when both are OFF.

In this operation example, it is determined in step S703 whether or not a proxy setting has been performed on the image processing apparatus 10, but this determination is not necessarily performed.

Also, in this operation example, it is determined in step S704 whether or not the authentication setting is ON and it is determined in step S705 whether or not the address filter setting is ON, and the setting is changed in a case when at least any one of the settings is OFF. However, the embodiment of the present invention is not limited thereto. Only one of the determination in step S704 and the determination in step S705 may be performed, and the setting may be changed if the setting is OFF.

The third exemplary embodiment is based on the assumption that processing using the EWS and SNMP is performed as processing for providing information held by the own apparatus via a communication unit, but the embodiment of the present invention is not limited thereto. Instead of the processing using the EWS and SNMP, or in addition to the processing using the EWS and SNMP, other processing may be performed.

Also, in the third exemplary embodiment, both the first operation example and the second operation example are performed, but only one of the first operation example and the second operation example may be performed. In a case when only the first operation example is performed, the example of the functional configuration of the information processing apparatus 60 may include only the parts related to the first operation example. In a case when only the second operation example is performed, the example of the functional configuration of the information processing apparatus 60 may include only the parts related to the second operation example.

Further, in the third exemplary embodiment, a state where the authentication data for administrator has not been changed from the default, a state where the authentication setting is OFF, and a state where the address filter setting is OFF are assumed as a state where leakage of information held by the own apparatus may occur, but another state may also be assumed.

A program that implements the exemplary embodiments may be provided by being stored in a recording medium such as a compact disc read only memory (CD-ROM), as well as be provided via a communication unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a warning unit that outputs a warning to change authentication information from an initial setting value in a case when the authentication information has not been changed from the initial setting value, the authentication information being used for authentication for using at least one service in which information held by the information processing apparatus is provided via a communication unit.

2. An information processing apparatus comprising:
a warning unit that outputs a warning to change a state of the information processing apparatus from a first state to a second state in a case when the information processing apparatus has a global IP address as an IP address and when the state of the information processing apparatus is the first state, the first state being a state in which leakage of information held by the information processing apparatus possibly occurs, the second state being a state in which leakage of the information held by the information processing apparatus is less likely to occur than in the first state.

3. The information processing apparatus according to claim 2, wherein the warning unit outputs a warning to change the state of the information processing apparatus from the first state to the second state in a case when the state of the information processing apparatus is the first state in which authentication information has not been changed from an initial setting value, the authentication information being used for authentication for using at least one service in which the information held by the information processing apparatus is provided via a communication unit.

4. The information processing apparatus according to claim 2, wherein the warning unit outputs a warning to change the state of the information processing apparatus from the first state to the second state in a case when the state of the information processing apparatus is the first state in which a function of performing authentication when another apparatus communicates with the information processing apparatus is disabled.

5. The information processing apparatus according to claim 4, wherein the warning unit outputs a warning, onto a screen of the information processing apparatus, to change the state of the information processing apparatus from the first state to the second state in a case when the state of the information processing apparatus is the first state in which the function of performing authentication when the other apparatus communicates with the information processing apparatus is disabled, and when the information held by the information processing apparatus is requested from an operation unit of the information processing apparatus.

6. The information processing apparatus according to claim 2, wherein the warning unit outputs a warning to change the state of the information processing apparatus from the first state to the second state in a case when the state of the information processing apparatus is the first state in which a function of limiting another apparatus that is allowed to communicate with the information processing apparatus is disabled.

7. The information processing apparatus according to claim 2, wherein the warning unit outputs a warning, onto a screen of another apparatus, to change the state of the information processing apparatus from the first state to the second state in a case when the IP address is a global IP address and when the other apparatus, which requests the information held by the information processing apparatus, has an IP address that is within a predetermined range.

8. The information processing apparatus according to claim 2, wherein the warning unit does not display a warning screen that prompts change of the state of the information processing apparatus in a case when the IP address is a global IP address and when identification information for identifying a proxy server has been set to the information processing apparatus.

9. An information processing apparatus comprising:
a change unit that changes a first state, which is a current state of the information processing apparatus, to a second state in which leakage of information held by the information processing apparatus is less likely to occur than in the first state, in a case when the information processing apparatus has a global IP address as an IP address.

10. The information processing apparatus according to claim 9, further comprising:
a generation unit that generates a new value of authentication information, the authentication information being used for authentication for using at least one service in which the information held by the information processing apparatus is provided,
wherein the change unit changes the first state to the second state, the first state being a state in which the authentication information has not been changed from an initial setting value, the second state being a state in which the authentication information has been changed to the new value.

11. The information processing apparatus according to claim 9, wherein the change unit changes the first state to the second state, the first state being a state in which a first number is set as the number of authentication failures that result in temporary disabling of authentication for using at least one service if failure of authentication is repeated more than or equal to the first number of times, the second state being a state in which a second number is set as a threshold of the authentication failures, the second number being smaller than the first number.

12. A non-transitory computer readable medium storing a program causing a computer to execute a process, the process comprising:
outputting a warning to change authentication information from an initial setting value in a case when the authentication information has not been changed from the initial setting value, the authentication information being used for authentication for using at least one service in which information held by an information processing apparatus is provided via a communication unit.

13. A non-transitory computer readable medium storing a program causing a computer to execute a process, the process comprising:
outputting a warning to change a state of an information processing apparatus from a first state to a second state in a case when the information processing apparatus has a global IP address as an IP address and when the state of the information processing apparatus is the first state, the first state being a state in which leakage of information held by the information processing apparatus possibly occurs, the second state being a state in which leakage of the information held by the information processing apparatus is less likely to occur than in the first state.

14. A non-transitory computer readable medium storing a program causing a computer to execute a process, the process comprising:
changing a first state, which is a current state of an information processing apparatus, to a second state in which leakage of information held by the information processing apparatus is less likely to occur than in the first state, in a case when the information processing apparatus has a global IP address as an IP address.
